(19) United States
(12) Patent Application Publication
(10) Pub. No.: US 2014/0197164 A1
(43) Pub. Date: Jul. 17, 2014

(54) WATERTIGHT HANDHOLE FOR THE TRANSIT OF CABLES IN OUTDOOR AREAS

(71) Applicant: Georgios Mavroeidis, Attikis (GR)

(72) Inventor: Georgios Mavroeidis, Attikis (GR)

(21) Appl. No.: 13/261,809

(22) PCT Filed: Aug. 13, 2012
(86) PCT No.: PCT/GR2012/000039

§ 371 Date: Feb. 6, 2014

(30) Foreign Application Priority Data
Aug. 11, 2011 (GR) 20110100486

(51) Int. Cl. H02G 9/10

(52) U.S. Cl. CPC H02G 9/10
USPC 220/3.8; 220/484

(57) ABSTRACT

A watertight handhole for the transit of cables in outdoor areas comprised of two cubic or other shaped units, one external and one internal, bonded together (monoblock), made of polyvinyl, cast iron, steel or stainless steel. The handhole of the present invention has one more unit than the known handholes in current use. Its external unit does not have a bottom floor and its sides are (partially) perforated for the removal of any water that may enter, protecting in this way the internal unit which houses the cables and the top of which closes with a flat plate that extends slightly beyond its main body. The bottom floor of the internal unit is conical and ends with a hole which is closed by a conical plug. Both the hole and the plug are threaded. The conical plug has a slot which allows it to be easily opened for the removal of water in the event the unit requires cleaning. The absence of flexible gaskets or metallic screws between the main bodies and plates of the units reduces the total cost of the handhole.

### FIELD OF THE INVENTION

The invention concerns a watertight handhole, for outdoor use, though which cables may be passed and accessed for service.

### BACKGROUND OF INVENTION

Currently, cable handholes are made either of concrete with cast iron or steel caps or of plastic (PVC) with caps of the same material. The disadvantage of such handholes is that their interior is not watertight. Water can enter through the space between the cap and the main body of the handhole and come in contact with cables which are susceptible to moisture.

In some of these handholes, water tightness can be achieved through the use of flexible gaskets placed between the cap and main body. These gaskets, however, present further disadvantages since, over time, they tend to lose their elasticity. The gasket material dries and the interior of the handhole is no longer watertight, while their frequent replacement increases the total cost of the handhole.

In handholes of this type, metal screws are often used, as parts of the cap to tighten the cap and gasket on the main body of the handhole. However, when the flexible gasket dries, the metal screws cannot be tightened enough to guarantee the interior of the handhole is watertight. Of course, any addition of screws, thus of additional parts, adds to the total cost of the hand hole.

Consequently, the problems associated with the use of such handholes include that they do not keep the interior dry, that the cables which pass through them may corrode, that metallic conductors may oxidize, that damage to the wiring may result, and that such handholes require either replacement of the flexible gaskets in a short time or the addition of parts such as metal screws, both of which increase the total cost of the handhole.

The use of gaskets or other connections such as screws in these handholes is complicated, requiring installation instructions and specially trained personnel to carry them out. Moreover, in order to access these handholes, the opening of the handhole cover requires the use of special tools and, consequently, of trained personnel. Such handholes present the additional problem of danger to the health and safety of the personnel who access them either to inspect the installation or to carry out some task, because the cables' location in a damp environment presents the danger of electrocution.

The techniques currently in use do not guarantee cables will pass through a watertight environment. Although handholes with a drain function do exist, none include a box that protects cables in a watertight environment. Relevant efforts at watertight handholes have been made, such as those reported in patent documents GB 2432974, US 006061975, FR 2742018, FR 2680609, EP 06200624. In these documents, there are no conduits connecting the internal with the external units of the box to ensure watertightness, so the cables are exposed. Likewise, in GR 2432979, FR 2742018, FR 2680609, EP 0620624, the handholes do not have separate handhole caps on the boxes of the internal and external units. Patents such as JP 2012023886, which have a drain function, do not ensure a watertight environment for the cables, because the effluent or water flows into the space occupied by the cables.

### SUMMARY OF THE INVENTION

The present invention describes a handhole for outdoor use which comprises two units, bonded together (monoblock construction), that allow the passage of cables in a watertight space wherever that might be, easy access to the work space and easy use of the boxes even by unspecialized personnel.

This handhole may be placed just below the surface of the ground with its cover at the surface or deeper, for example, in sidewalks, cement surfaces, multi-leveled asphalt highways, dirt roads and gardens.

The handhole described in the present invention consists of an external and an internal unit, which may be square, or another shape, and which are made of polyvinyl (PVC), iron, steel or stainless steel. The external unit does not have a bottom, but remains open at its base, allowing any inflow of surface water to escape into the ground below, while from above, it is closed with a cap of appropriate mechanical resistance.

The four sides of the external unit are penetrated by four horizontal conduits, one conduit through each side, so that the conduits are at right angles to each other. Each horizontal conduit begins from an opening in the corresponding wall of the internal unit and extends slightly beyond the wall of the external unit (allowing connection to cable conduits). The internal unit is closed from above with a flat cap which extends 1.5 mm beyond its main body all around, while its bottom is conical (or pyramidal), ending in a threaded hole. This hole is blocked with a threaded, plastic plug. Furthermore, to speed the outflow of any water which might enter the external unit of the handhole, the four side walls (of the external unit of the handhole) are perforated from the lowest point of the conduits on down.

The advantages of the handhole described here stem from the two units, internal and external, which maintain a watertight environment for the cables found inside the internal unit. The internal unit is smaller than the external unit and the cap on top extends beyond its main body by 1.5 mm all around. As a result, any water that enters under the cap of the external unit runs down its side walls in the space between it and the smaller internal unit, to the ground, from which it is absorbed by way of, first, the external unit's open bottom and, second, its perforated side walls.

In this way, the handhole of this invention differs materially from the regular handholes currently in use which have only one unit in which the cables are housed. Also, the presence of bottoms in such current handholes invite the collection of moisture in the space where the cables are housed, resulting in corrosion of the cables and exposing personnel who may have to work on them to the danger of electrocution.

Moreover, on the (two) caps which are installed on top of the main bodies of the external and internal units of the handhole of this invention, no flexible gaskets are used between the body of each unit and its cap, nor are other parts, such as metal screws, needed, nor are specially trained personnel required. As a result, the handhole of this invention is easy for non-expert personnel to install and to access for subsequent work.

The absence of flexible gaskets in the handhole of this invention, which (gaskets) have a short useful life and which require early replacement, holds down the overall cost in comparison to handholes currently in use.

The thin gauge (1-3 mm) of the side walls of the main bodies of both the external and internal units renders the handhole of this invention light in weight.

Likewise, access to the internal unit from its bottom, which is conical (pyramidal) and ends in a threaded hole closed with a plastic plug, is easy. The conical plug is used to drain the network in case it had been washed. The access is easy because after having removed the two caps, the plug is visible at the center of the bottom of the internal unit and has an external slot-shaped recess which allows it to be unscrewed with the use of a simple screwdriver, a house key or a coin.

The present invention guarantees a watertight environment in the interior space of the unit where the cables are found, with the result that the cables do not come in contact with water, do not corrode and do not become a safety hazard for the personnel who access the handhole.

The connection of the four conduits of the handhold to cable conduits can be accomplished by non-expert personnel, because at the point of connection, on the exterior of the external unit, the conduits end in rebated edges of typical commercial dimensions. For full watertight protection of the handhole with the rest of the conduit network, PVC adhesive can be used to seal the connection of the four conduits with the conduits.

### BRIEF DESCRIPTION OF THE DRAWINGS

The invention is shown in the attached FIGS. 1 to 4.

FIG. 1 shows an overhead view of the handhole and its structure, which includes: the main body of the external unit (1) and its cap (2). FIG. 1 also shows the side walls of the internal unit (3), the cap of the internal unit (4), the conical (pyramidal) bottom of the internal unit (5), the hole at the tip of the conical bottom (6) and the four conduits (7, 8, 9 and 10) which begin at the internal unit and pass through the external unit (1).

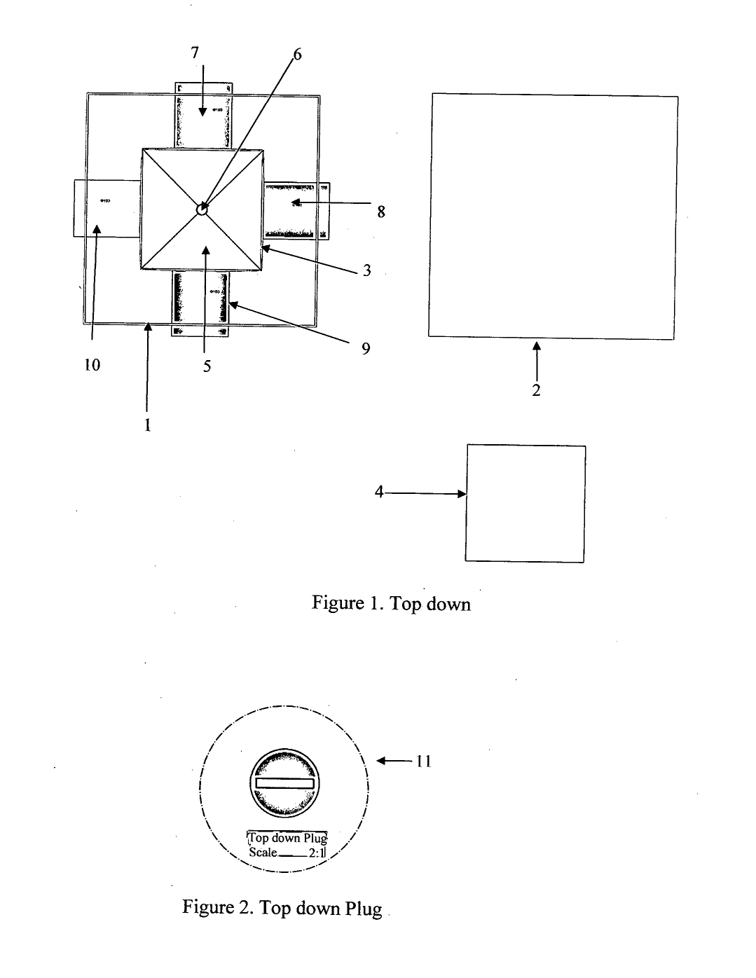

FIG. 2 shows the exterior end of the plug (11) with which the hole of the conical (pyramidal) bottom (6) of the internal unit (3) is sealed.

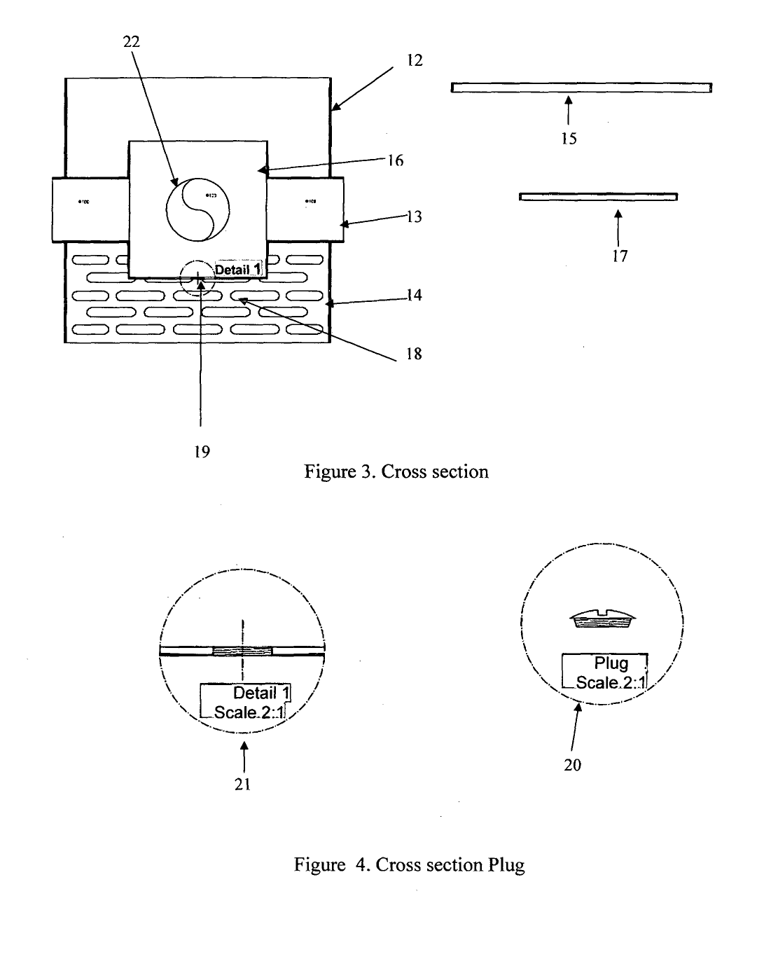

FIG. 3 shows a cross section of the handhole:
at (12) the solid area of the four side walls of the main body of the external unit, from the level of the cap to the lowest point of the conduits from the internal unit (13),
at (14) the perforated area of the four side walls of the main body of the external unit from the lowest point of the internal unit conduits and below,
at (15) the external unit cap,
at (16) the internal unit of the handhole,
at (17) the internal unit cap,
at (18) the bottom of the internal unit,
at (19) the threaded hole in the tip of the internal unit bottom,
at (22) the end (rebated edge) of one of the two internal unit conduits which lie at right angles to the conduits at (13)

FIG. 4 shows:
at (20) a close-up of the threaded plug which seals the threaded hole (19) at the bottom of the conical (pyramidal) floor of the internal unit,
at (21) a close-up of the threaded hole (19) of the internal unit of the handhole.

### DETAILED DESCRIPTION OF THE INVENTION

The present invention describes a handhole for outdoor use which comprises two units, one internal and one external, bonded together (monoblock construction), and which ensures the transit of cables in a watertight environment.

The handhole has a square (or other) shape external unit (1) and a smaller internal unit (3) of the same shape, with a space between the two. Each unit consists of a main body with four side walls and a cap to cover the top. Both units are constructed of polyvinyl (PVC), although cast iron, steel or stainless steel may also be used. The external unit is covered on top by a flat cap (2). The handhole described here may be placed with its cap at the surface of the ground or deeper. If the handhole is placed with its external unit cap at surface level (2), it must be made of polyvinyl (PVC), cast iron, steel or stainless steel of sufficient mechanical resistance to support the weight of automobile wheels.

The external unit (1) does not have a bottom floor.

The internal unit (3) which bears the cables has a flat cap on top and a plug at the bottom. The flat cap (4) is large enough to extend slightly (1.5 mm is indicated) beyond the main body on all sides. The conical (or pyramidal) bottom of the internal unit (5) ends in a threaded hole (6).

The plug is conical and seals the hole in the bottom of the internal unit of the handhole. The plug (20) has threads which correspond to the threads of the hole.

From each side of the internal unit (3) begins a conduit (7 to 10) which then passes through an opening in the corresponding side of the external unit. The conduits lie in a horizontal position and form right angles with each other. That is, conduits (7) and (9) are at right angles to conduits (8) and (10). The four conduits which pass through the external unit walls are easy, thus without specialized personnel to be required to carry it out, to connect to other cable conduits of the network because each conduit ends in a rebated edge (22) and is of standard commercial dimension. For full watertight protection of the handhole and conduit network, PVC adhesive may be applied at the point of connection (22) on each of the conduits.

With the present invention the watertight environment around the cables is ensured because:
the handhole comprises two units rather than one. The cables are housed in the internal unit (3).

The external unit does not have a bottom floor, and in this way, should water enter under its cap, the water flows down to the ground and does not collect inside the external unit. To increase the outflow of any water that may enter under the cap of the external unit and to ensure greater protection of the internal unit that houses the cables, the sides of the external unit are perforated (14) from the bottom of the conduits on down.

The handhole of the present invention differs substantially from handholes currently in use which consist of only one unit and which have a bottom floor that blocks the outflow of water from the unit.

The removal of water which may enter under the cap of the external unit, and its direction to the ground, is enhanced by the dimensions of the internal unit's cap (4) which extends beyond its main body (1.5 mm is indicated).

Flexible gaskets, such as are used in other handholes currently in use, are not used in the handhole of the present invention, i.e. neither between the external unit and its cap nor between the plug and the threaded hole of the internal unit's bottom floor. Such gaskets require replacement in a short time as they tend to dry and lose their elasticity. Thus, the handhole of the present invention is more economical.

Also, it is more economical because other parts, such as metallic screws used to secure the caps of handholes currently in use, are not used in the handhole of the present invention. These screws are used to increase the pressure of the cap and gasket against the main body, and they add to the cost.

The absence of flexible gaskets and connectors (such as screws) renders the present invention easy to use and easy to access, because the sequential opening of the external unit cap (2) and the internal unit cap (4) do not require specialized personnel. Similarly easy to open is the threaded plug that closes the threaded hole in the internal unit bottom floor. This can be accomplished using a simple screwdriver, a house key, or even a coin. The hole (6) can be opened by unscrewing the conical plug (20) to allow the immediate removal of water in the event that cleaning of the conduit network is judged necessary.

1. A handhole for outdoor use for the watertight passage of cables, comprising an external unit (1), said external unit (1) comprising side walls with an open bottom and an open top covered with a cap (2) arranged proximally to the surface of the ground and characterised in that it further comprises an internal unit (3) defining a watertight space for the passage of cables, said internal unit (3) comprising a main body with side walls, a closed bottom (5) and an open top covered with a cap (4), said internal unit (3) being smaller than said external unit (1), a space being provided between said external unit (1) and said internal unit (3) whereby any water entering under the cap (2) of the external unit (1) runs downwardly in the space provided between said external unit (1) and said internal unit (3) into the ground, at least one opening being provided in said side walls of the internal unit (3) and at least one opening being provided in said side walls of the external unit (1), said at least one opening of the internal unit (3) being located oppositely said at least one opening of the external unit (1), at least one conduit (7, 8, 9, 10) extending horizontally outwardly said at least one opening of said side walls of the internal unit (3), through a corresponding said at least one opening of said side walls of the external unit (1).

2. A handhole according to claim 1, characterized in that it is being produced in a monoblock construction consisting of said external unit (1) comprising said at least one opening in the side walls thereof and said internal unit (3) comprising said at least one opening in the side walls thereof and said at least one conduit (7, 8, 9, 10) extending horizontally outwardly said at least one opening of said side walls of the internal unit (3) through a corresponding said at least one opening of said side walls of the external unit (1).

3. A handhole according to claim 1, characterized in that said at least one conduit (7, 8, 9, 10) extending horizontally outwardly said at least one opening of said side walls of the internal unit (3) through a corresponding said at least one opening of said side walls of the external unit (1), protrudes exteriorly said external unit (1) with rebated edges having standard commercial dimensions for connection thereof to conduits of a cable network.

4. A handhole according to claim 1, characterized in that the bottom (5) of said internal unit (3) is conical or pyramidal, a threaded hole (6) being provided at the center of said bottom (5) of said internal unit (3), a threaded conical plug (11) being adapted to seal said threaded hole (6).

5. A handhole according to claim 4, characterized in that said threaded plug (11) is provided with a slot-shaped recess allowing unscrewing thereof.

6. A handhole according to claim 1, characterized in that said cap (4) extends marginally beyond the main body of said internal unit (3) thereby enhancing guiding downwardly to the ground water entering under said cap (2) of the external unit (1).

7. A handhole according to claim 1, characterized in that a portion (14) of said side wall of said external unit (1) lying beneath said at least one conduit (7, 8, 9, 10) is perforated thereby enhancing outflow of water entering under said cap (2) of said external unit (1).

8. A handhole according to claim 1, characterized in that said conduits (7, 8, 9, 10) extending outwardly said at least one opening in the side walls of the internal unit (3) and passing through a corresponding opening in the side walls of the external unit (1) are at right angles to each other thereby forming a cross shaped pattern.

9. (canceled)

10. A handhole according to claim 2, characterized in that said at least one conduit (7, 8, 9, 10) extending horizontally outwardly said at least one opening of said side walls of the internal unit (3) through a corresponding said at least one opening of said side walls of the external unit (1), protrudes exteriorly said external unit (1) with rebated edges having standard commercial dimensions for connection thereof to conduits of a cable network.

11. A handhole according to claim 2, characterized in that the bottom (5) of said internal unit (3) is conical or pyramidal, a threaded hole (6) being provided at the center of said bottom (5) of said internal unit (3), a threaded conical plug (11) being adapted to seal said threaded hole (6).

12. A handhole according to claim 11, characterized in that said threaded plug (11) is provided with a slot-shaped recess allowing unscrewing thereof.

13-15. (canceled)
